(19) United States
(12) Patent Application Publication
(10) Pub. No.: US 2008/0095481 A1
(43) Pub. Date: Apr. 24, 2008

(54) DIFFERENTIAL WHEEL MOUNTING FOR A RAILROAD CAR

(76) Inventor: John Kummings, Crawfordsville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/961,706

(22) Filed: Dec. 20, 2007

Related U.S. Application Data
(63) Continuation-in-part of application No. 11/359,652, filed on Feb. 22, 2006, now Pat. No. 7,316,436.

(51) Int. Cl. B60B 37/10; B60B 17/00; B61F 15/00

(52) U.S. Cl. 384/158; 295/44

(57) ABSTRACT

A differential wheel mounting for replacing a standard railroad axle assembly having a wheel seat portion which includes a sleeve, a railroad wheel with a running surface for contacting a rail and a rolling bearing assembly detachably mounted to the sleeve and railroad wheel. The sleeve may include a shoulder and removable keeper for retaining the rolling bearing assembly. The wheel may also include a shoulder and removable keeper for retaining the rolling bearing assembly. The rolling bearing assembly sustains both radial and thrust loads during normal operation of a railroad car. The wheel may also include a removable tire section.

### CROSS-REFERENCE TO RELATED APPLICATIONS

The present application is a continuation-in-part of prior application Ser. No. 11/359,652, filed Feb. 22, 2006, which is hereby incorporated by reference in its entirety.

### BACKGROUND

The present disclosure resides generally in the field of railroad wheels with removable tire sections as well as differential wheel mounting for railroad cars.

Wheelsets commonly in use on the majority of freight railroad cars in the United States have two wheels firmly press-fit onto a common axle over a raised wheel seat. This provides a very high torsional rigidity between the two wheels which forces the two wheels to rotate at the same rotational velocity. The wheel set assembly may be supported by either journal bearings out-board of each wheel, normally at the end of the axle, or the bearings may be located in-board of the wheels. The running surfaces of the wheels are generally profiled such that the wheels are effectively conical in shape, at least when new. However, wheel wear normally quickly changes the straight cone to a hollowed cone in which the effective conicity of the running surface varies with the lateral position of the running surface.

The combination of the effective coning of the wheel's running surface and the rigid axle connection between the two wheels provides a basic mechanism by which a conventional axle with two fixed wheels steers itself. If the wheels are laterally displaced from the center of the track, the wheel that is closer to flange contact has a larger rolling radius than the other wheel. Approximately equal and opposite longitudinal forces are generated on the wheels as the wheel with a larger rolling radius pulls the wheelset forward while the wheel with the small rolling radius pulls the wheelset back. This creates a moment that induces a yaw in the wheelset. This yaw tends to “steer” the wheelset toward the centerline of the track. However, this characteristic of self steering can lead to oscillatory instability otherwise known as hunting, especially at high speeds.

Another problem with conventional railroad wheelsets is encountered on curved sections of track. Operation over sections of curved track ideally requires the wheels to rotate at different speeds because the wheel on the outside rail has to traverse more rail than the wheel on the inside rail. When the wheels are coupled together, the different speeds the wheels are forced to rotate cause slippage between one or both wheels and the rails while traversing curves. This slippage causes wear on both the running surfaces of the wheels and the rails and is a significant cause of maintenance to both wheels and track. Furthermore, the constant slipping that occurs on curved sections of track significantly increases the rolling resistance generated by the conventional wheelset.

As a solution primarily to the problem of slippage while traversing curved sections of track, various wheel and axle constructions have been previously disclosed which permit one or both wheels on a common axle to rotate independently of that axle, i.e., differential wheel rotation. However, these previous arrangements have either been complicated and costly or have lacked sufficient durability to be useful or have otherwise not been accepted in the marketplace.

Nevertheless, the search for a viable solution to these problems common to the railroad industry has continued on over the years. With the nation and world possibly turning more to rail travel for goods and people in the future with ever-growing fuel and energy concerns, this need may be even greater in the years to come. That need is the reason and subject of the present disclosure.

### BRIEF DESCRIPTION OF THE DRAWINGS

FIG. 1 is a perspective view of an embodiment of the present disclosure;

FIG. 2 is a transverse sectional view of the structure in FIG. 1 along section line 2-2 of FIG. 1;

FIG. 3 is an exploded view of the components of FIG. 1 and FIG. 2;

FIG. 4 is a sectional view of a portion of FIG. 2;

FIG. 5 is a perspective view of an alternate embodiment of the bearing member;

FIG. 6 is a perspective view of an alternate embodiment of the bearing member;

FIG. 7 is a sectional view of an alternate embodiment of a representative bearing member.

FIG. 8 is a sectional view of an alternate embodiment of a representative bearing member;

FIG. 9 is a sectional view of an alternate embodiment of a representative bearing member;

FIG. 10 is an cross sectional view illustrating an embodiment of the wheel running surface.

FIG. 11 is a half a sectional view of an embodiment of a rolling member bearing.

FIG. 12 is an exploded view of the components of FIG. 11;

FIG. 13 is a sectional view of an alternate embodiment of the representative rolling member bearing.

FIG. 14 is a sectional view of an embodiment of a railroad wheel.

FIG. 15 is a sectional view of an embodiment of the structure in FIG. 2.

### DETAILED DESCRIPTION

While the present disclosure may be embodied in many different forms, for the purpose of promoting an understanding of the principles of the present disclosure, reference will now be made to the embodiments illustrated in the drawings, and specific language will be used to describe the same. It will nevertheless be understood that no limitation of the scope of the disclosure is thereby intended. Any alterations and further modifications in the described embodiments and any further applications of the principles of the present disclosure as described herein are contemplated as would normally occur to one skilled in the art to which the disclosure relates.

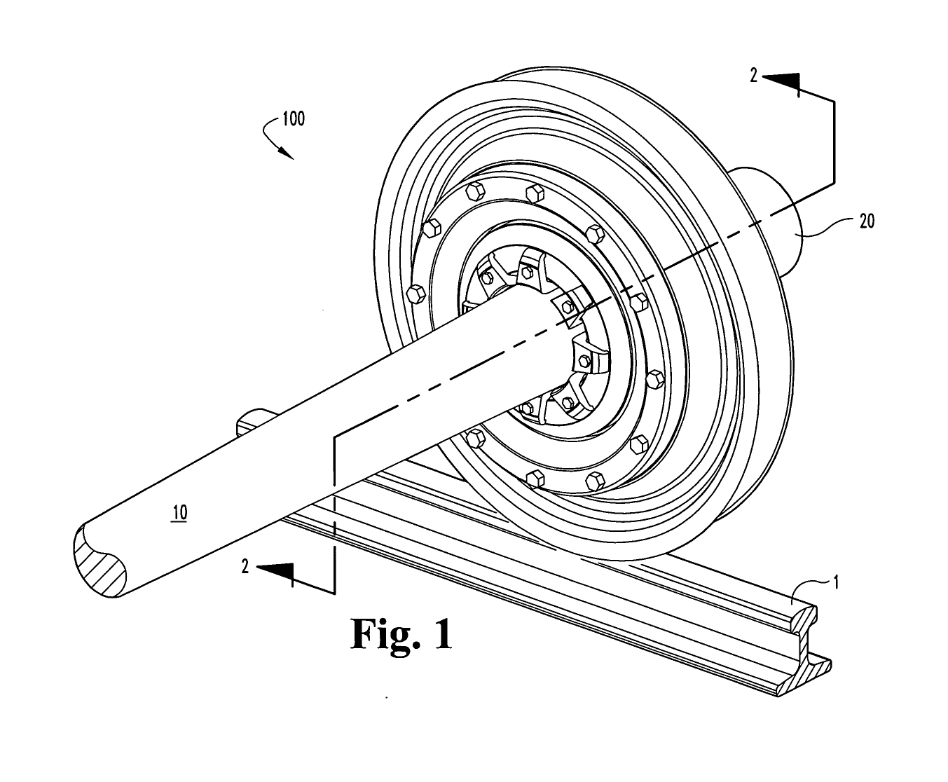

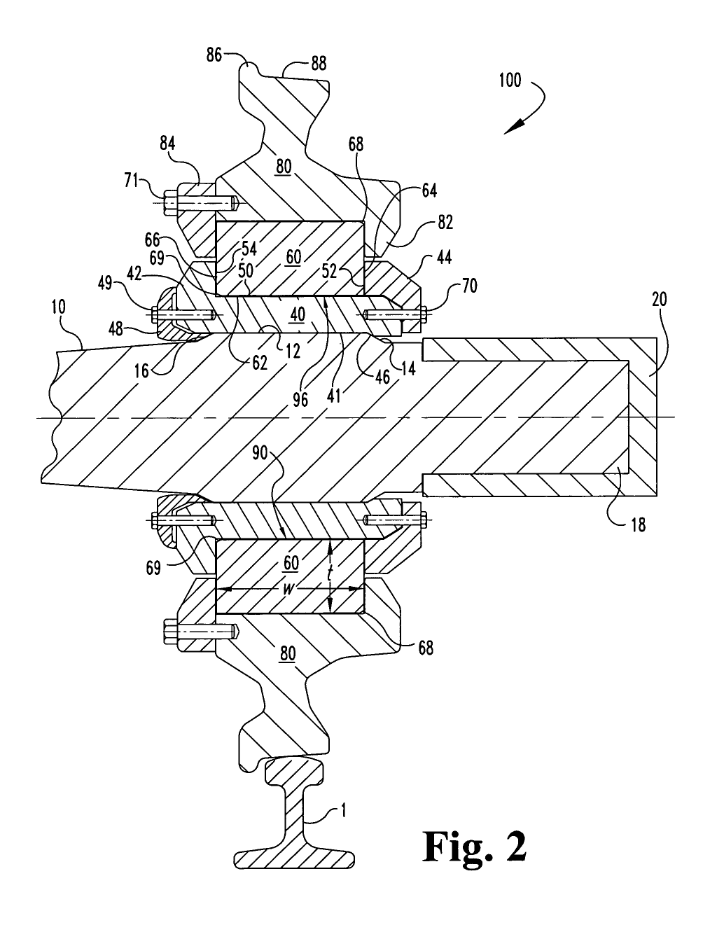

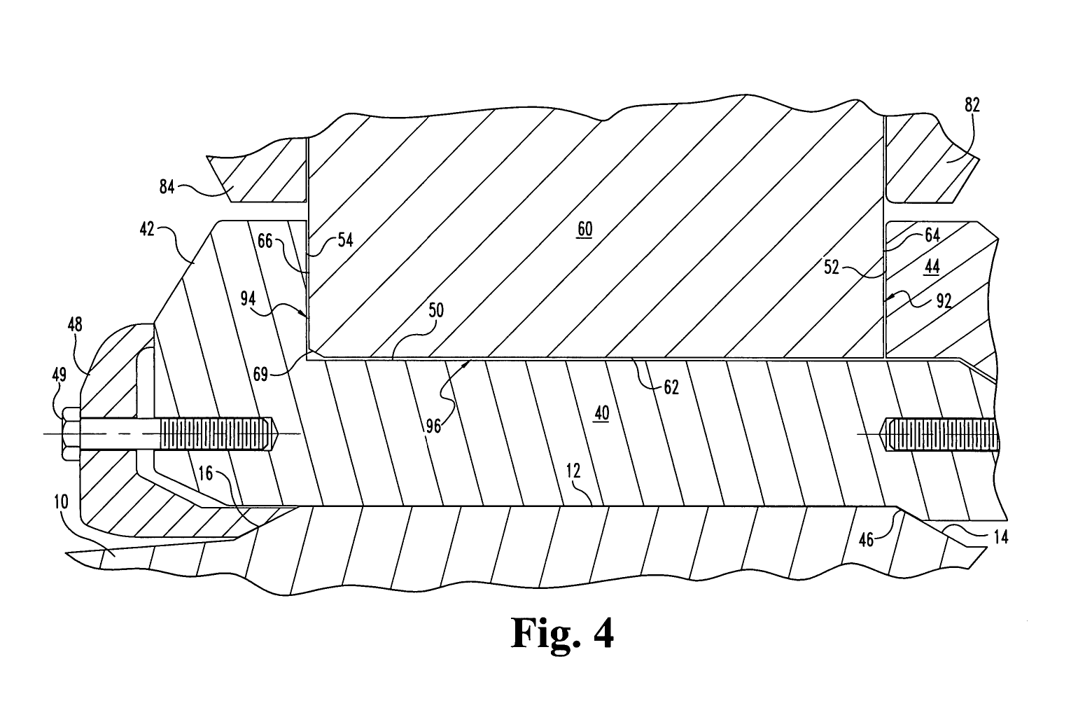

Referring to the drawings in detail, and first in particular to FIGS. 1-3, an embodiment of a differential wheel mounting, indicated generally as 100, is shown as attached to a railroad car axle 10 having a raised wheel seat portion 12 as is common. The raised wheel seat portion 12 normally includes an outboard taper 14 and an inboard taper 16 which substantially transitions the diameter of axle 10 from the raised wheel seat portion 12 to the smaller axle diameter on either side of raised wheel seat portion 12 as shown in FIGS. 2 and 4. Railroad car axle 10 normally has a standard railroad wheel press fit on the other end of the axle (not illustrated) and normally is connected to a railroad wheel truck assembly (not illustrated) via two journal bearings (one journal bearing 20 is illustrated in FIGS. 1-3.) The railroad wheel truck assembly is connected to various types of railroad cars in any manner known to those skilled in the art.

The differential wheel mounting 100 shown in the drawings then generally includes: 1) sleeve 40 mounted on raised wheel seat 12; 2) plain bearing member 60 rotationally coupled to sleeve 40 such that plain bearing member 60 can rotate about sleeve 40, but lateral movement in either direction along the axis of the axle relative to sleeve 40 is substantially confined; 3) railroad wheel 80 securely mounted to bearing member 60 such that railroad wheel 80 can rotate with bearing member 60, while both bearing member 60 and wheel 80 are also laterally confined with respect to sleeve 40. When differential wheel mounting 100 is assembled, wheel 80 is rotationally engaged relative to sleeve 40 on axle 10. In this regard, “plain bearing” as used herein refers to a bearing member which carries a load by sliding as a result of surface to surface contact, without rollers, ball bearings or any other mechanical means being employed. Unless specified otherwise, all bearings 60 referred to herein are intended to be plain bearings within this definition. Furthermore, “laterally confined” as used herein refers to a bearing or other member being generally held or retained in place relative to some other member (but may include some slip or play being present in light of assembly tolerances and expected wear characteristics between components consistent with industry standards.)

Referring further to FIGS. 2-4, sleeve 40 preferably is adapted to be press fit on raised wheel seat 12 utilizing methods known to those skilled in the art. However, in one embodiment of the disclosure, sleeve 40 is press fit on the raised wheel seat 12 utilizing substantially less force than is normally utilized to press fit a standard railroad wheel of a particular size on the raised wheel seat 12. In this embodiment, deformation of sleeve 40 due to being tightly press fit on the raised wheel seat 12 is minimized. In another embodiment of the disclosure, sleeve 40 is press fit on the raised wheel seat 12 using substantially similar force that is commonly utilized to press fit a standard railroad wheel on the raise wheel seat 12, which is known to be between about 90-160 tons for 36″ wheels or between about 80-150 tons for 33″ wheels.

Sleeve 40 also preferably includes an interior lip 46 as illustrated in FIGS. 2 and 4. Interior lip 46 preferably limits how far sleeve 40 can be press fit over the raised wheel seat portion 12 by engaging outboard taper 14 when sleeve 40 is located sufficiently far inboard. Interior lip 46 can be oriented at an angle or other geometry corresponding to substantially mate with the angle of outboard taper 14; or, in the alternative, interior lip 46 can make a substantially 90 degree angle (not illustrated) relative to sleeve interior 41. In yet another embodiment, outboard taper 14 can be modified by machining a standard axle to have a 90 degree shoulder in lieu of a taper to better interface with alternate embodiments of sleeve 40 and sleeve clamps 48. However, the precise geometry of interior lip 46 is not believed critical, and any geometry known to those skilled in the art is contemplated within the scope and coverage of the disclosure herein.

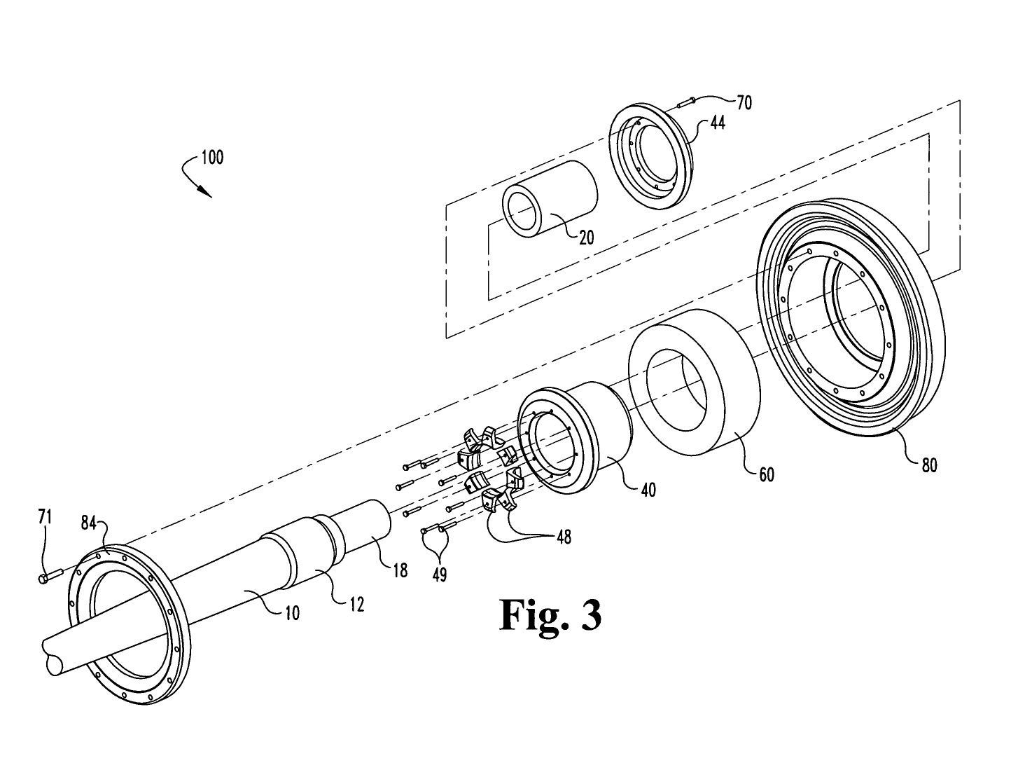

In any case, when interior lip 46 is engaged with outboard taper 14 as illustrated in FIGS. 2 and 4, interior lip 46 may also function to transfer axial forces between axle 10 and sleeve 40, as is the case in the present embodiment, in which the force used to press fit sleeve 40 onto wheel seat 12 is thereby reduced. In addition, as illustrated in FIG. 3, a number of sleeve clamps 48 are preferably mounted around the inboard side of sleeve 40 utilizing bolts 49 such that each sleeve clamp 48 exerts pressure on inboard taper 16 as illustrated in FIG. 4. When thus engaged as illustrated in FIG. 4, sleeve 40 is thereby preferably firmly affixed to axle 10 regardless of the force used to press fit sleeve 40 onto wheel seat 12. In yet another embodiment, inboard taper 16 can be modified by machining a standard axle to have a 90 degree shoulder in lieu of a taper. In this embodiment the geometry of sleeve clamps 48 would preferably also be altered to include a blunt end to maximize the interface with modified inboard taper 16.

Sleeve 40 also preferably includes a shoulder 42 and a keeper ring 44 as illustrated in FIGS. 2 and 4. Moreover, sleeve 40, shoulder 42 and keeper ring 44 preferably form a circumferential recess that retains plain bearing 60 within sliding surfaces 50, 52 and 54 such that bearing surfaces 62, 64, and 66 are slideably engaged against sliding surfaces 50, 52 and 54 and bearing 60 rotates about sleeve 40 while being substantially confined from movement in a lateral direction along the axle 10. Sleeve 40, shoulder 42 and keeper ring 44 are preferably constructed of stainless steel. However, other materials and configurations are also envisioned for sleeve 40, shoulder 42 and keeper ring 44 within the scope and coverage of this disclosure. Sliding surfaces 50, 52 and 54 are preferably hardened and polished or otherwise treated such as known in the art to increase their wear resistance characteristics. Keeper ring 44 is preferably mounted on sleeve 40 with a number of bolts 70 spaced around the circumference for stability and strength. In an alternative embodiment, shoulder 42 could also be removably mounted directly on sleeve 40 utilizing bolts spaced around its circumference. In this embodiment, shoulder 42 would preferably be separated from sleeve 40 in a fashion similar to the separation of keeper ring 44 so that shoulder 42 does not contact wheel seat 12 (not illustrated). In yet another embodiment, through bolts could be used to secure keeper ring 44 and shoulder 42 onto sleeve 40 (not illustrated). However, it is understood and intended that any means for fastening keeper ring 44 or shoulder 42 to sleeve 40 known to those skilled in the art is contemplated by the present disclosure.

Plain bearing 60 is then preferably a combination bearing in the sense that it effectively carries or sustains both radial loads normal to axle 10 and thrust loads substantially along the axis of axle 10. This embodiment, bearing 60 transfers all loads between wheel 80 and sleeve 40 and is sufficient in terms of construction, strength and stability to support the load of a loaded railroad car in and during normal operation.

As illustrated in FIG. 2, plain bearing 60 is also preferably fixedly mounted in railroad wheel 80. To accomplish this, railroad wheel 80 preferably also includes a shoulder 82 and a removable keeper ring 84 which substantially secure bearing member 60 inside wheel 80. Railroad wheel 80 preferably also includes flange 86 and running surface 88, both adapted to contact rail 1 as shown in FIGS. 1 and 2. Running surface 88 may have a tread slope of about 1:20 as illustrated in FIG. 10, which is in line with some thoughts as to industry standards for new wheel construction. However, running surface 88 can be any other desired slope or shape as would be known to or used by those skilled in the art. While it is preferable that bearing 60 be fixedly mounted in railroad wheel 80, it is also preferable that bearing 60 be removable from wheel 80 when necessary as illustrated in FIG. 3. Separating bearing 60 and wheel 80 preferably permits replacement or maintenance of either bearing 60 or wheel 80 to occur independently of the replacement or maintenance requirements of the other. Furthermore, as new or better performing or lower cost materials become available, it is possible to replace one component without unnecessarily replacing the other component if that is desired.

In an alternate embodiment, it is envisioned that the relative rotation of the wheel with respect to the sleeve may occur between wheel 80 and bearing 60 instead of or in addition to between bearing 60 and sleeve 40. In this embodiment, wheel 80 could engage plain bearing 60 in a manner similar to where bearing 60 is slidably engaged with sleeve 40 as in the preferred embodiment above. In this embodiment, for example, it could be beneficial for the surfaces on wheel 80 that could slide with respect to bearing 60 to be a material with good wear characteristics such as hardened and polished stainless steel.

Keeper ring 84 is then mounted on wheel 80 with a number of bolts 71 spaced around the circumference as shown in FIG. 1. In an alternative embodiment, shoulder 82 could be a separate member that is also removably mounted on wheel 80 utilizing bolts spaced around the circumference to secure shoulder 82 onto wheel 80 (not illustrated). In another embodiment, through bolts could again be used to secure both ring 84 and shoulder 82 onto wheel 80 (not illustrated). However, any means for fastening ring 84 and shoulder 82 onto wheel 80 known to those skilled in the art is contemplated herein as well.

Separation of bearing 60 from sleeve 40 to perform maintenance can also preferably and readily be accomplished with an economy of steps in the present disclosure. Specifically, as illustrated in FIG. 3 for example, it is preferable that keeper 44 and bearing 60 can be disengaged from sleeve 40 and removed from axle 10 without disturbing or removing journal bearing 20. Keeper 44 preferably fits over journal bearing 20 or, alternatively, keeper 44 can be split into several pieces (not illustrated) which can be individually removed while journal bearing 20 is in place on axle 10. The smallest internal diameter of bearing 60 is preferably large enough that bearing 60, with wheel 80 attached, can still be removed from sleeve 40 and axle 10 over journal bearing 20. This arrangement preferably simplifies maintenance procedures and can be a significant time and money savings to the railroad during normal operation.

While the particular shape and dimensions of plain bearing member 60 may vary according to the embodiments described herein, the preferred configuration of plain bearing member 60 as depicted in FIGS. 2 and 3 is generally ring shaped having a width w a thickness t as shown in FIG. 2. From testing thus far, it is preferred that width w should be at least about two times the dimension of thickness t. In a typical 36″ wheel arrangement, as generally represented in FIGS. 2 and 3, preferred bearing member 60 is shown with a thickness t of about 4 inches and a width w of about 8 inches.

As for material composition, bearing plain member 60 is preferably a solid, homogenous, block of a low-friction polymeric material. The preferred material at this time is known as VESCONITE HILUBE and is marketed and available from VescoPlastics Sales, PO Box 40647, Cleveland, Johannesburg, 2022 South Africa. However, other bearing materials or configurations are also envisioned within the scope and coverage of this disclosure. For example, plain bearing member 60 could be made from a solid block of a low-friction ceramic material. Alternatively, a substantial portion of plain bearing member 60, including its core, could be made of a metallic material while bearing surfaces 62, 64 and 66 are surfaced or coated or otherwise bonded with a long wearing bearing material such as TEFLON or any one of many other bearing materials that are known to those skilled in the art (not illustrated).

As for its manufacture, plain bearing member 60 is also preferably a cast polymer material. However, it is also envisioned that plain bearing member 60 could be manufactured by any machining process or any other process known to those skilled in the art. The corners 68 and 69 of plain bearing 60 are also preferably chamfered at approximately a 30 degree angle and a depth of 2-3 mm to ease assembly and limit scoring, as illustrated in FIGS. 2 and 4. The other corners of plain bearing 60 should or may also be broken to limit edge chipping during assembly as well.

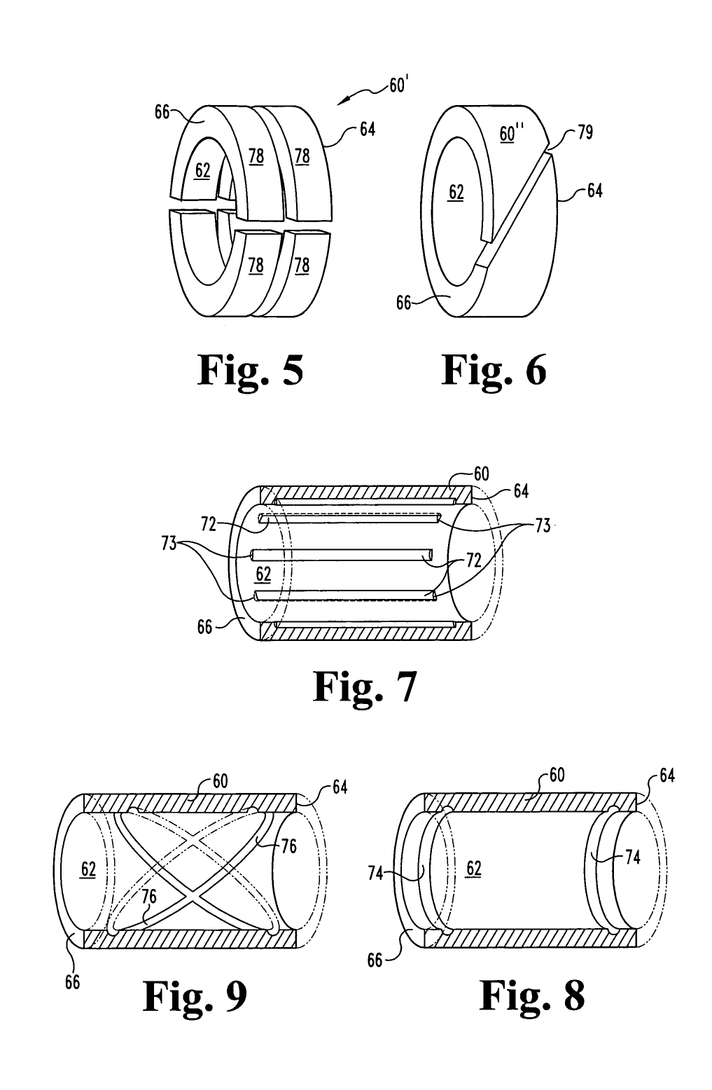

While bearing member 60 is preferably a continuous block of material as described above, it is also envisioned that bearing member 60 could be manufactured in segments as illustrated in FIG. 5 in an alternate embodiment. It could be advantageous to manufacturer bearing member 60 in segments due to manufacturing or assembly issues. For example, in some cases it may be easier to obtain the tolerances required by casting plain bearing 60 in several, smaller detachable members due to shrinkage and warping issues involved in casting thick sections of some materials. FIG. 5 illustrates plain bearing 60′ being split horizontally and axially into four detachable bearing members 78. It is also pointed out that some bearing materials may require or benefit from such a split plain bearing arrangement to facilitate installation or expansion and contraction of plain bearing 60 due to temperature variations. For example, FIG. 6 illustrates an alternate embodiment of plain bearing 60″ which includes a single split 79 that is preferably angled to improve the contact area of plain bearing 60″ and to preferably reduce any eccentricity created by the split. Ample consideration should be given to the specifications set by the manufacturer of a particular bearing material when determining the optimum configuration of bearing member 60.

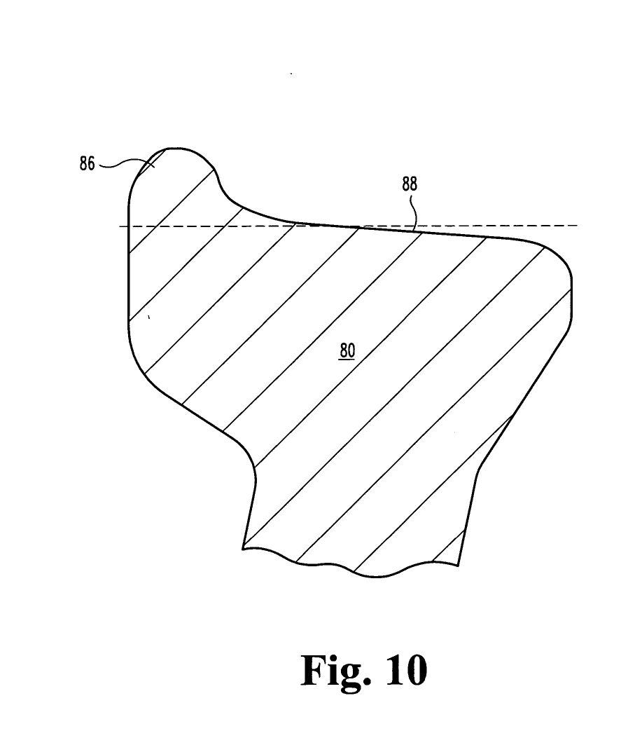

As illustrated in FIG. 7, plain bearing 60 in the embodiments herein also preferably includes one or more blind grooves 72 to improve its overall performance. Blind grooves 72 form an effective dirt and debris trap that helps reduce scoring of the bearing surfaces while the blind ends 73 help keep any additional dirt or debris away from the plain bearing surfaces as well. For the embodiment where plain bearing 60 is made of VESCONITE HILUBE, such blind grooves 72, if used, should be at least 2 mm deep and at least 3 mm wide to be effective for such purposes. Alternatively, plain bearing 60 can include circular end grooves 74 such as illustrated in FIG. 8 or loop grooves 76 as illustrated in FIG. 9. These alternative groove geometries can provide improved lubricant distribution if and when external lubrication may be used, while also keeping dirt or debris away from the plain bearing surfaces during normal and extended use as well. In this regard, it is noted that plain bearing 60 and grooves 72, 74, and 76 are not intended to be necessarily illustrated to any particular scale in FIGS. 7-9, but are there primarily to illustrate possible configurations and locations for such grooves, if desired. For materials other than VESCONITE HILUBE, ample consideration should be given to the specifications set by the manufacturer to determine whether to use grooves and the optimum configuration of any grooves that are used.

Still referring to these plain bearings 60 in the embodiments herein, there are several characteristics that the material used for these plain bearing surfaces preferably possesses. First, it is preferable that the plain bearing material used exhibit characteristics of relatively long wear life in order to maximize the life of the plain bearing surfaces and thereby minimize their replacement. It is also advantageous for the plain bearing material to exhibit characteristics of internal or self lubrication to lessen or avoid the necessity of external lubrication. However, use of an external lubricant is also envisioned within the embodiments of the disclosure herein. If used, the bearing and sliding surfaces in these embodiments would be preferably lubricated during assembly, but would not require additional external lubrication after assembly or during use. Situations and constructions where no external lubrication whatsoever is utilized are envisioned as well, as stated above, as are differential wheel mountings that may require or receive external lubrication through a grease fitting or other means. In this same regard, the use of any such suitable materials as bearing surfaces for plain bearing 60 is envisioned within the scope and coverage of the disclosure herein. Ample consideration should also be given to the manufacturer's recommendations for possible lubrication of a particular bearing material used in this application.

Other material characteristics and design considerations for the VESCONITE HILUBE can be found in the “VESCONITE and VESCONITE HILUBE Design Manual” which is incorporated by reference herein. This design manual is available at www.vesconite.com.

Plain bearing member 60 will also preferably include three bearing surfaces 62, 64 and 66. As illustrated in FIG. 4, there will also be clearances between sliding surfaces 50, 52 and 54 and bearing surfaces 62, 64 and 66. Clearance 90, as illustrated in FIG. 2, represents the clearance between sliding surface 50 and bearing surface 62 on the load bearing side of differential wheel mounting 100. Clearance 96 represents the clearance between sliding surface 50 and bearing surface 62 on the non-load bearing side of differential wheel mounting 100. In normal operation, the weight of the railroad car forces sliding surface 50 and bearing surface 62 substantially together at the location of clearance 90 while the clearance at the location of clearance 96 widens. As the wheel rotates, the location of clearance 90 and 96 also rotates to maintain the orientation illustrated in FIG. 2. Clearance 92 represents the clearance between sliding surface 52 and bearing surface 64 as illustrated in FIG. 4. Clearance 94 represents the clearance between sliding surface 54 and bearing surface 66 as illustrated in FIG. 4. In normal operation, when the railroad car traverses a curve in which differential wheel mounting 100 is located on the outside rail of the curve, the longitudinal load sustained by wheel 80 may force bearing surface 66 to slide against sliding surface 54, minimizing clearance 94 and maximizing clearance 92.

The exact or preferred clearances 90, 92, 94 and 96 which should be used will vary based upon the materials used in plain bearing member 60, bearing surfaces 62, 64, and 66 and to some extent upon sliding surfaces 50, 52, 54. Ample consideration should be given to the clearance specifications set by the manufacturer of a particular bearing material when determining the clearances for a particular application.

In one embodiment of the current disclosure, it is preferable to control the static friction between sliding surfaces 50, 52, and 54 and bearing surfaces 62, 64 and 66 such that rotational sliding between plain bearing 60 and sleeve 40 only occurs when necessary to prevent slippage of one or both wheels when traversing a curved section of track. Controlling the static friction between sliding surfaces 50, 52, and 54 and bearing surfaces 62, 64 and 66 is preferably accomplished by varying parameters of hardness, roughness, lubrication and clearances 90, 92, 94 and 96 while accounting for the reaction to the weight of the railroad car across sliding surfaces 50, 52, and 54 and bearing surfaces 62, 64 and 66 during normal operating conditions. In this regard, the static friction between sliding surfaces 50, 52, and 54 and bearing surfaces 62, 64 and 66 will preferably be greater than the force required to generate opposite longitudinal forces in wheel 80 to create a steering moment generally sufficient to direct flange 86 away from contact with rail 1 when running on substantially straight track. However, the static friction which preferably arises from the reaction to the weight of the railroad car will preferably be low enough for any slippage that must occur when traversing a curved section of track will occur between sliding surfaces 50, 52 and 54 and bearing surfaces 62, 64 and 66 rather than between running surface 88 and rail 1. An alternate approach is to control the static friction such that rotation between sleeve 40 and plain bearing 60 only preferably occurs when torque is encountered that is significantly less than what is required to cause slippage between running surface 88 and rail 1 when both are relatively dry during normal conditions as well.

It is also preferable that multiple standard sizes of sleeve 40 and plain bearing 60 be manufactured and stocked by companies in order to allow flexibility when retrofitting existing axles and when replacing components. Multiple sizes of sleeve 40 will preferably allow for normal variations in the actual size of raised wheel seat portion 12 while also maintaining desired fit characteristics as discussed herein and as would be understood by those ordinarily skilled in this industry. Multiple sizes of plain bearing 60 will preferably allow for sliding surface 50 to be reworked if it becomes excessively worn or damaged without having to deposit additional material on sleeve 40 in order to build up sliding surface 50 to its original diameter. In this way, over time, a wide variety of reworked sleeves 40 with different outer diameters corresponding to sliding surface 50 can be accommodated by manufacturing various plain bearings 60 with incrementally different internal diameters at their bearing surfaces 62.

In this same way, it is also preferable that multiple configurations of sleeves 40 be manufactured wherein the location of interior lip 46 is varied to accommodate variations in the location and size of raised wheel seat portion 12 and outboard taper 14. Alternatively, in embodiments in which sleeve 40 is press fit on raised wheel seat 12 with sufficient force to maintain the position of sleeve 40 on raised wheel seat 12, the position of sleeve 40 when mounted on raised wheel seat 12 can be controlled by how far onto raised wheel set 12 sleeve 40 is press fit thereby reducing the variants of sleeve 40 required. In this situation internal lip 46 may be preferably omitted from sleeve 40 in order to maximize the utility of individual configurations of sleeve 40.

In the initial retrofit of the differential wheel mounting 100 of the present disclosure, it is noted that conventional wheel and axle assemblies need to be removed from their interconnection to a standard railroad car or other similar structure. A conventional railroad wheel is preferably first removed from one end of the standard railroad car axle 10 after first removing the adjacent outer axle journal bearing 20. However, it is noteworthy that, for some configurations, it may be possible to remove the standard railroad wheel over the adjacent outer axle journal bearing. In this case, it may be advantageous to perform the initial retrofit while leaving the outer axle journal bearing in place. In any event, only one of the conventional railroad wheel members needs to be removed and replaced in order to enable and accomplish the benefits and the operation of the preferred embodiments of this disclosure as described herein.

More specifically regarding the initial retrofit situation, after removing the conventional railroad wheel from the raised wheel seat 12, wheel seat 12 is carefully inspected to determine its size as well as its fitness to be further utilized. Any required machining to adjust wheel seat 12, outboard taper 14 or inboard tapers 16 can then be preformed. Next, the position of the remaining conventional wheel in relation to the outboard taper 14 of the wheel seat 12 is preferably measured to determine how far onto wheel seat 12 sleeve 40 should be placed in order to properly position railroad wheel 80 in relation to the conventional railroad wheel remaining to ensure proper engagement with the intended rail gauge. The appropriate sleeve 40 is then selected to insure proper fit as detailed above. Sleeve 40 is then press fit onto wheel seat 12 until the desired position is reached.

The next step in assembly of the differential wheel mounting is normally to install plain bearing member 60 inside wheel 80. This is accomplished by inserting the desired plain bearing member 60 into the recess in wheel 80 until plain bearing member 60 contacts shoulder 82. Keeper ring 84 is then affixed to wheel 80 such that plain bearing member 60 is securely held between keeper ring 84 and shoulder 82. It is also envisioned that plain bearing 60 could be press fit into wheel 80. It is envisioned that this embodiment in which plain bearing 60 is press fit into wheel 80 may be most applicable when plain bearing 60 is substantially made of a metallic material. However, at the same time, it is understood and intended that any means for fastening plain bearing 60 to wheel 80 known to those skilled in the art is contemplated by the present disclosure.

The next assembly step is normally installing the assembled wheel 80 and plain bearing member 60 onto sleeve 40. Bearing surfaces 62, 64 and 66 of plain bearing member 60 are generally first pre-lubricated, if desired, and then carefully installed, preferably by sliding plain bearing 60 over sliding surface 50 of sleeve 40 until bearing surface 66 substantially contacts shoulder 42. Keeper ring 44 may be then installed and affixed to sleeve 40. In one embodiment of the present disclosure, keeper ring 44 may be segmented (not illustrated) to allow installation of keeper ring 44 over the top of journal 20 where the interior diameter of keeper ring 44 may be too small to permit installation over journal bearing 20. In any event, as previously discussed, it is understood and intended that any means for fastening keeper ring 44 to sleeve 40 known to those skilled in the art is contemplated by the present disclosure.

At this point, wheel 80 is preferably rotatable about axle 10 independently of the rotation of axle 10 by the contact between bearing surfaces 62, 64 and 66 with sliding surfaces 50, 52 and 54. This provides the standard railroad car axle with one wheel that is capable of independent wheel rotation. This in turn permits the relative rotation or slipping of one of the railroad wheel members on rounding a curve which preferably substantially reduces frictional wear between the running surface 88 of the railroad wheel 80 and rail 1.

It is also noted that while one of the embodiments of the disclosure disclosed above locates the surfaces of rotation between plain bearing 60 and sleeve 40, it is also contemplated that the actual bearing surfaces and surfaces of rotation could be located between wheel 80 and plain bearing 60. In such an embodiment or situation, plain bearing 60 is preferably firmly coupled to sleeve 40 and wheel 80 would preferably have surfaces of rotation that are adapted for long wear life similar to those disclosed for sleeve 40 above (not illustrated).

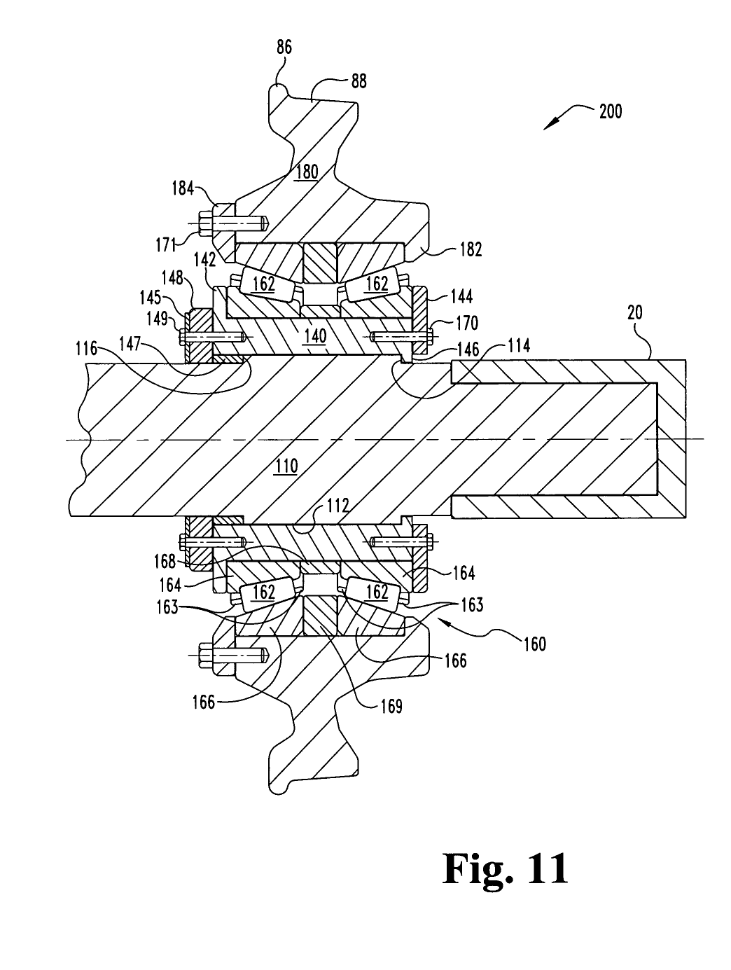

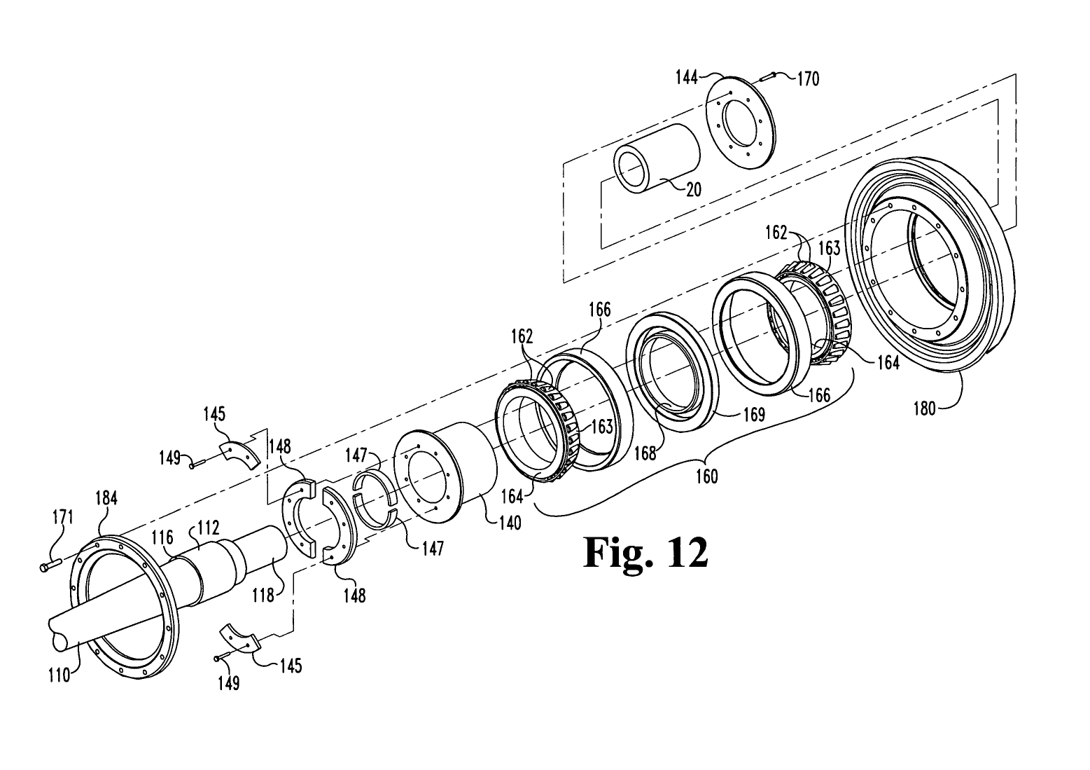

Referring to FIGS. 11 and 12, an embodiment of a differential wheel mounting utilizing a rolling bearing, indicated generally as 200, is shown as attached to a railroad car axle 110 having a raised wheel seat portion 112. The raised wheel seat portion 112 in this embodiment has been modified from outboard taper 14 and inboard taper 16, as illustrated in FIGS. 2-4, to form outboard step 114 and inboard step 116. This modification may be done by machining axle 110 to remove the typical taper and replace it with a step. Outboard step 114 and inboard step 116 may be formed such that approximate right angles are formed relative to raised wheel seat portion 112.

The differential wheel mounting shown in FIGS. 11 and 12 generally includes: 1) sleeve 140 mounted on raised wheel seat 112; 2) rolling member bearing assembly 160 fixedly coupled to sleeve 140 such that lateral movement in either direction along the axis of the axle relative to sleeve 140 is substantially confined; 3) railroad wheel 180 securely mounted to rolling member bearing assembly 160 such that railroad wheel 180 is also laterally confined with respect to sleeve 140. When differential wheel mounting 200 is assembled, wheel 180 is rotationally engaged relative to sleeve 140 on axle 110.

Rolling member bearing assembly 160 may be comprised of one or more rolling bearing components such as tapered roller bearings, tapered thrust roller bearings, needle bearings, ball bearing, roller bearings or any other rolling bearing element known to those skilled in the art. In this regard, “rolling bearing,” as used herein, generally refers to a bearing member that carries a load by rolling, commonly between two surfaces. In some embodiments, “rolling bearing,” refers to a complete package of one or more rolling elements, and two or more race elements. In still further embodiments, “rolling bearing” also encompasses a cage, retainer, separator or other structure used to confine the rolling elements in or near the race elements as well as lubricant and sealing structures intended to keep lubricant in proximity with the rolling elements and races as well as to form a barrier to keep external contaminates away from the rolling bearing elements. As a collective assembly, rolling member bearing assembly 160 should sustain and transfer both radial and thrust loads experienced during normal operation of differential wheel mount 200.

Referring again to FIGS. 11 and 12, rolling member bearing assembly 160 is illustrated comprising a plurality of tapered roller bearings 162, two bearing separators 163, two separate bearing inner races 164, two bearing outer races 166, a inner race spacer 168 and a outer race spacer 169. In the illustrated embodiment, tapered roller bearings 162 are separated from each other by bearing separators 163 such that tapered roller bearings 162 are engaged with bearing inner races 164 and bearing outer races 166. In another embodiment, which is not illustrated, the two bearing outer races 166 and the outer race spacer 169 could be replaced by a single, double outer race element, as known in the art. For example, some tapered roller bearing manufactures make a double row taper roller bearing which includes a double outer race element in which the individual outer race elements are effectively a single unit with minimal space in between the individual tapered outer race elements. It may also be possible for a manufacturer to make a double outer race element that includes a more substantial space in between the individual tapered outer race elements incorporated together. It is worth noting that appropriate sealing structures have been omitted from FIGS. 11 and 12 for clarity. However, it is assumed and recommended that such appropriate sealing structures as specified or provided by the manufacturer of the other rolling bearing elements should be utilized.

In any event, and in either configuration, bearing outer race 166 is rotatable with respect to bearing inner race 164 through the rolling of tapered roller bearings 162. Furthermore, the illustrated bearing assembly 160 effectively carries or sustain both radial loads normal to axle 110 and thrust loads substantially along the axis of axle 110. In some embodiments, rolling member bearing assembly 160 transfers all loads between wheel 180 and sleeve 140 and is sufficient in terms of construction, strength and stability to support the load of a loaded railroad car in and during normal operations.

Referring further to FIGS. 11 and 12, in one embodiment, sleeve 140 is adapted to be press fit on raised wheel seat 112 utilizing methods known to those skilled in the art. In another embodiment, sleeve 140 could be press fit on the raised wheel seat 112 utilizing substantially less force than would normally used to press fit a standard railroad wheel of a particular size on raised wheel seat 112. In this embodiment, any deformation of sleeve 140 due to being tightly press fit on raised wheel seat 112 should be minimized.

In the embodiment illustrated in FIG. 11, sleeve 140 also includes an interior lip 146. Interior lip 146 may limit how far sleeve 140 can be press fit over the raised wheel seat portion 112 by engaging outboard step 114 when sleeve 140 is located sufficiently far inboard. When interior lip 146 is engaged with outboard step 114, as illustrated in FIG. 11, interior lip 146 may also function to transfer axial forces between axle 110 and sleeve 140. This is particularly true in the embodiment in which the force used to press fit sleeve 140 onto wheel seat 112 is reduced.

Furthermore, as illustrated in FIGS. 11 and 12, clamp spacer 147 is located next to sleeve clamp 148, sleeve clamp 148 being attached to sleeve 140 by one or more cap screws 149. When assembled in this manner, sleeve clamp 148 exerts pressure on clamp spacer 147. This should result in a clamping pressure being applied between clamp spacer 147 and interior lip 146 that securely attaches sleeve 140 to axle 110. As illustrated in FIG. 12, clamp spacer 147 and sleeve clamp 148 is split into two or more pieces which may facilitate their positioning inboard of raised wheel seat 112. In addition, as illustrated in FIGS. 11 and 12, seam plate 145 may be included over any splits in sleeve clamp 148 to reinforce sleeve clamp 148 at the location of the split. Seam plate 145 covers the portion of sleeve clamp 148 over a split in sleeve clamp 148 from a bolt 149 in one segment of sleeve clamp 148 to another cap screws 149 in another segment of sleeve clamp 148. In any event, seam plate 145 is an optional feature that should only be utilized as necessary.

In the embodiment illustrated in FIGS. 11 and 12, sleeve 140 includes shoulder 142 and a keeper ring 144. Moreover, as illustrated, sleeve 140, shoulder 142 and keeper ring 144 form a circumferential recess that retains bearing assembly 160. In this embodiment, bearing assembly 160, and in particular bearing inner races 164, are retained on sleeve 140 by a clamping force generated between shoulder 142 and keeper ring 144. Alternatively, or in addition, bearing inner races 164 may be press fit onto sleeve 140. It is understood and intended that any means for fastening rolling bearing assembly to sleeve 140 known to those skilled in the art is contemplated by the present disclosure.

Keeper ring 144 is mounted on sleeve 140 with a number of cap screws 170 spaced around the circumference for stability and strength. In another embodiment, shoulder 142 could also be removably mounted directly on sleeve 140 utilizing cup screws spaced around its circumference. In this embodiment, shoulder 142 may be separated from sleeve 140 in a fashion similar to the separation of keeper ring 144 (not illustrated). In yet another embodiment, through bolts could be used to secure keeper ring 144 and shoulder 142 onto sleeve 140 (not illustrated). However, it is understood and intended that any means for fastening keeper ring 144 or shoulder 142 to sleeve 140 known to those skilled in the art is contemplated by the present disclosure.

Referring to FIG. 11, rolling member bearing assembly 160 is fixedly mounted in or to railroad wheel 180. Railroad wheel 180 may also include shoulder 182 and a removable keeper 184, which substantially secures rolling member bearing assembly 160 inside wheel 180. Railroad wheel 180 may be secured to rolling member bearing assembly 160 by a clamping force applied to bearing outer races 166 which is generated between shoulder 182 and keeper 184. Alternatively, or in addition, railroad wheel 180 may be secured to rolling member bearing assembly 160 by press fitting bearing outer races 166 inside railroad wheel 180. In any event, it is understood and intended that any means for fastening rolling member bearing assembly 160 to wheel 180 known to those skilled in the art is contemplated by the present disclosure.

Railroad wheel 180 also includes flange 86 and running surface 88, both adapted to contact a rail 1. Running surface 88 is illustrated having a tread slope of about 1:20, which is in line with some thoughts as to industry standards for new wheel construction. However, running surface 88 may be any desired slope or shape as would be known to those skilled in the art. In addition, while in some embodiments rolling member bearing assembly 160 is fixedly mounted to wheel 180, in other embodiments bearing assembly 160 may be removable from wheel 180 when necessary, as illustrated in FIG. 12. In some embodiments, separating rolling member bearing assembly 160 and wheel 180 permits replacement or maintenance of either rolling member bearing assembly 160 or wheel 180 to occur independently of the replacement or maintenance requirements of the other. In this embodiment, as new or better performing or lower cost materials become available, it would be possible to replace one component without unnecessarily replacing the other component, if that is desired.

Still referring to the embodiment illustrated in FIGS. 11 and 12, keeper ring 184 is mounted on wheel 180 with a number of bolts 171 spaced around the circumference. In an alternate embodiment, shoulder 182 could be a separate member that may also be removably mounted on wheel 180 utilizing cap screws spaced around the circumference to secure shoulder 182 onto wheel 180 (not illustrated). In another embodiment, through bolts may be used to secure both keeper 184 and shoulder 182 onto wheel 180 (not illustrated). In any event, any means for fastening keeper 184 and shoulder 182 onto wheel 180 known to those skilled in the art is also contemplated herein.

Separation of rolling member bearing assembly 160 from sleeve 140 to perform maintenance can also preferably and readily be accomplished with an economy of steps in the present disclosure. Specifically, as illustrated in FIG. 12, keeper 144 and rolling member bearing assembly 160 can be disengaged from sleeve 140 and removed from axle 110 without disturbing or removing journal bearing 20. Keeper 144 preferably fits over journal bearing 20 or, alternatively, keeper 144 may be split into several pieces (not illustrated) which may be individually removed while journal bearing 20 is in place on axle 110. In the illustrated embodiment, the smallest internal diameter of rolling member bearing assembly 160 is large enough that rolling member bearing assembly 160, with wheel 180 attached, can be removed from sleeve 140 and axle 110 over journal bearing 20. This arrangement should simplify maintenance procedures and could be a significant time and money savings to the railroad during normal operation.

In an alternative embodiments, multiple standard sizes of sleeve 140 could be manufactured and stocked in order to allow flexibility when retrofitting existing axles and when replacing components. Multiple sizes of sleeve 140 could allow for normal variations in the actual size of raised wheel seat portion 112 while also maintaining desired fit characteristics as discussed herein and as would be understood by those of ordinary skill in this industry. In the same way, it may be advantageous that multiple configurations of sleeve 140 be manufactured wherein the position of interior lip 146 is varied to accommodate variations in the location and size of raised wheel seat portion 112 and outboard step 114. Various configurations of sleeve 140 may also be manufactured to accommodate different geometries of outboard step 114. For example, it may be desirable to not modify outboard step 114, leaving it as a tapered transition. In that case, a sleeve configuration similar to that disclosed above could be used to interface with the tapered transition. In the alternative, in embodiments in which sleeve 140 is press fit on raised wheel seat 112 with sufficient force to maintain the position of sleeve 140 on raised wheel seat 112, internal lip 146 may be omitted from sleeve 140 in order to maximize the utility of individual configurations of sleeve 140.

Bearing assembly 160 may be composed of standard sized bearing components; custom manufactured bearing components; or a combination of standard components with custom components. For example, in the embodiment illustrated in FIG. 11, tapered roller bearing 162, bearing separator 163, bearing inner race 164 and bearing outer race 166 depict standard components that may be manufactured by multiple suppliers in standard sizes. On the other hand, inner race spacer 168 and/or outer race spacer 169 could be components custom manufactured for a particular application. Utilization of standard components, where possible, should decrease costs and increase the availability of spare parts. In this regard, multiple sizes of sleeve 140 could also allow for variations in what standard components could be used on the basis of availability or costs, especially when various manufactures may have differing standard sizes or configurations.

Referring to the components encompassed within the definition of rolling member bearing assembly 160, there are several characteristics that these components may advantageously possess. First, it may be advantageous for these components to exhibit characteristics of relatively long wear life in order to maximize the life span of rolling member bearing assembly 160 and thereby minimize component replacement. Any material known to those skilled in the art may be utilized for these components, including but not limited to, stainless steal, case hardened bearing steel or ceramics. It may also be advantageous for rolling member bearing assembly 160 to be sealed with sufficient lubrication to avoid the necessity of external lubrication. However, use of an external lubricant source is also envisioned within the disclosure herein. In addition, it may be preferable to sufficiently lubricate rolling member bearing assembly 160 by thoroughly greasing or immersing in oil before assembly, to potentially prevent unwanted damage to the rolling bearing surfaces due to insufficient operating lubrication. In any event, ample consideration should be given to the specifications set by the manufacturer of each individual component utilized to ensure adequate lubrication during all phases of the expected life of each component in rolling member bearing assembly 160. Wherein oil-based lubricants have been disclosed herein, any appropriate lubricant known to those skilled in the art is contemplated.

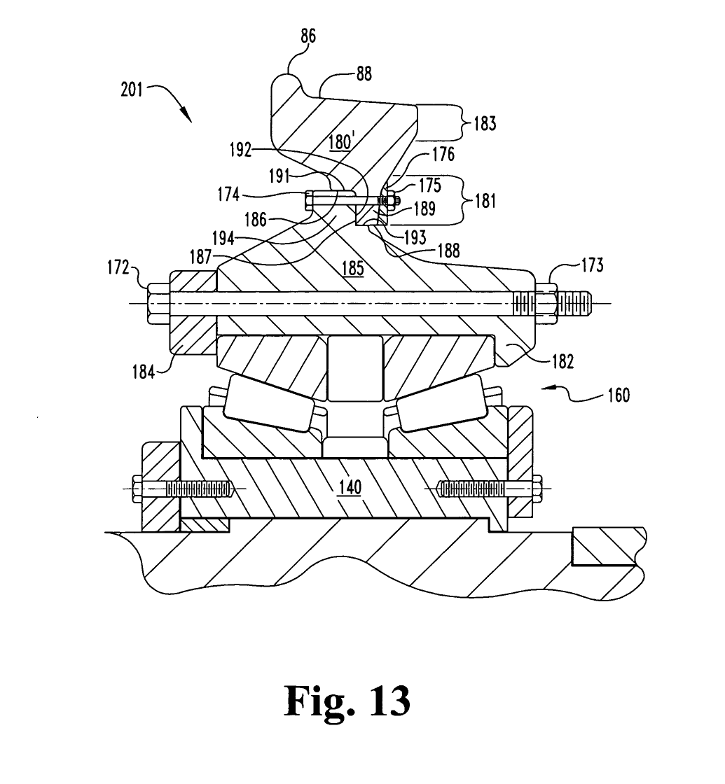

Referring to FIG. 13, another embodiment of the disclosure is illustrated generally as differential wheel mounting 201 in which wheel 180′ is removably mounted to wheel adapter 185. Wheel 180′ may be the outer portion of a standard railroad wheel in which the hub portion or web portion has been damaged to the point the railroad wheel may be unusable. Alternatively, wheel 180′ may be made specifically for this application. This disclosed configuration may allow repair or replacement of individual components 180′ and 185 while the other components remain in service. Separating wheel 180′ from wheel adapter 185 could also permit each component to be made from different materials. For example, it could be advantageous to construct wheel 180′ from a material having exceptional wear characteristics wherein it could be advantages to construct wheel adapter 185 from a material having exception strength characteristics. Alternatively, each component could have different treatments, such as heat treating or annealing, applied such that the material characteristics of wheel adapter 185 are substantially different than the material characteristics of wheel 180′. These characteristic may include, but are not limited to, impact strength, hardness, wear resistance and strength. These different characteristics may be difficult to simultaneously maximize in some materials, such as steel, such that the potential life expectancy of each component may be substantially increased by tailoring the characteristics of each individual component as opposed to having to use substantially the same material or same treatment for an entire railroad wheel.

As illustrated in FIG. 13, wheel adapter 185 includes shoulder 182 and keeper 184, as detailed above, to permit attachment to rolling member bearing assembly 160 as detailed above. Alternatively, wheel adapter 185 could be configured to accept plain bearing member 60 as detailed above and disclosed in FIGS. 1-10 (not illustrated). Wheel 180′ is illustrated in FIG. 13 attached to wheel adapter 185 via a bolt 174 and nut 175. Also illustrated is angled spacer 176 which preferably matches the contour of wheel 180′ to provide a flattened surface for nut 175 to rest against. Angled spacer 176 could be in the form of a ring that extends around with wheel 180′ or angled spacer 176 could be in the form of a plurality of segments located under one or more bolt and nut assemblies. In this regard, it should be understood that FIG. 13 is but a partial sectional view of the differential wheel mounting. Bolt 174, nut 175 and angled spacer 176 are but representative components. An appropriate number of bolts 174, nuts 175 and angled spacers 176 are spaced around the wheel adapter 185 and wheel 180′ as appropriate to sufficiently attached wheel 180′ to wheel adapter 185.

Still referring to the embodiment illustrated in FIG. 13, wheel 180′ includes edges 186, 187 and 188, wherein edge 187 and edge 188 define shoulder 189. Similarly, wheel adapter 185 includes edges 191, 192 and 193 wherein edge 192 and 193 define shoulder 194. Shoulder 194 interfaces with shoulder 189 to withstand potential lateral forces that may be encountered during normal operation. Similarly, edge 191 interfaces with edge 186 and edge 193 interfaces with edge 188 to withstand potential compressive forces encountered during normal operation.

In other embodiments of FIG. 13, it is envisioned than any known alternative means of mechanically fastening wheel 180′ to wheel adapter 185, known to those skilled in the art, could be utilized. For example, bolt 174 could be replaced with a rivet as is known in the art. Alternatively, bolt 174 could be replaced with a cap screw that is threaded into either shoulder 189 or shoulder 194. In the embodiment illustrated in FIG. 13, if a cap screw were to be threaded into should 194 then angled spacer 176 would also be preferably utilized to provide a better surface to interact with the head of a cap screw.

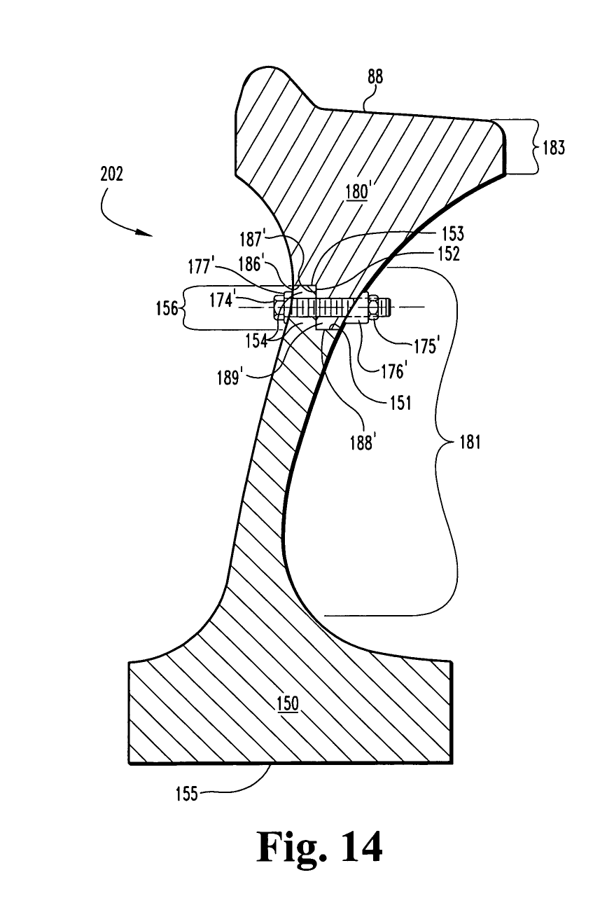

Referring to FIG. 14, yet another embodiment of the disclosure is illustrated as railroad wheel 202. Railroad wheel 202 is a non-differential wheel mounting. It is analogous to a standard railroad wheel as is known to those skilled in the art. Railroad wheel 202 includes wheel 180′ and wheel hub 150. Wheel hub 150 is coupled to wheel 180′ in a manner similar to the method used to couple wheel adapter 185 to wheel 180′ in FIG. 13. For example, as illustrated in FIG. 14, wheel 180′ includes edges 186′, 187′ and 188′, wherein edge 187′ and edge 188′ define shoulder 189′. Wheel hub 150 includes edges 151, 152 and 153 wherein edge 152 and 153 define shoulder 154. Shoulder 154 interfaces with shoulder 189′ to withstand potential lateral forces encountered during normal operation. Similarly, edge 151 interfaces with edge 188′ and edge 153 interfaces with edge 186′ to withstand potential compressive forces encountered during normal operation.

Still referring to the embodiment illustrated in FIG. 14, wheel hub 150 is attached to wheel 180′ via a plurality of bolts 174′ and nuts 175′. The bolt and nut assemblies include an angled spacer 176′ positioned between wheel 180′ and nut 175′ to provide a flattened surface for nut 175′ to rest against. In addition, angled spacer 177′ is positioned between the head of bolt 174′ and hub 150 to provide a flattened surface for bolt 174′ to rest against.

Once again, as discussed for the embodiment illustrated in FIG. 13, in alternative embodiments of FIG. 14 it is envisioned than means other than bolt 174′ and nut 175′ could be utilized to mechanically fasten wheel 180′ to wheel adapter 185. As previously discussed, bolt 174′ could be replaced with a rivet as is known in the art. Alternatively, bolt 174 could be replaced with a cap screw that is threaded into either shoulder 189′ or shoulder 154. In either case, angled spacer 176′ and/or angled spacer 177′ can be utilized, as appropriate, to proved a flat surface to interact with whatever mechanical fastening device is utilized.

Wheel hub 150, as illustrated in FIG. 14, could be the inner portion of a standard railroad car wheel in which the tire portion has been damaged while the hub portion remains in a usable condition. Alternatively, wheel hub 150 could be manufactured specifically for this application. Wheel hub 150 may be press fit on a standard railroad axle having a raised wheel seat portion, as is known in the art.

Still referring to FIG. 14, in one embodiment wheel hub 150 and wheel 180′ could be constructed of different materials. Alternatively, wheel hub 150 and wheel 180′ could be constructed of the same type of material, but each component may have had different treatments applied, such as heat treating or annealing, that would make the material characteristics of wheel hub 150 and wheel 180′ substantially different. However, it should be understood that wheel hub 150 and wheel 180′ in FIG. 14 do not have to have different characteristics to be within the scope of this disclosure. Thus, wheel hub 150 and wheel 180′ could be constructed of the same type of material with the same type of treatments so that the material characteristics of both are substantially similar. On advantage of the configuration depicted in FIG. 14 is that separation of wheel 180′ from wheel hub 150 may permit the repair or replacement of individual components while the other component may remain in service.

Referring to FIGS. 13 and 14, it may be preferable for wheel 180′ to be removed from either wheel adapter 185 or wheel hub 150 without disturbing or removing the other components of the associated assemblies. This may facilitate easier and/or faster repair or replacement of wheel 180′ than may be possible if the entire assemblies 201 and/or 202 would also have to be removed to allow such repair or replacement. This configuration may also facilitate repair or replacement of wheel 180′ in the field, away from dedicated service facilities.

Referring to FIGS. 13 and 14, wheel 180′ includes web portion 181 of a standard railroad wheel. Web portion 181 has a substantially reduced cross sectional thickness as compared to tire portion 183 of the wheel. Specifically regarding FIG. 14, the illustrated junction area 156 between wheel 180′ and wheel hub 150 is but one possible junction point envisioned in this disclosure. Junction area 156 could be located either closer to running surface 88 or closer to axle interface 155 as needed to permit reuse of undamaged portions of otherwise unusable wheels.

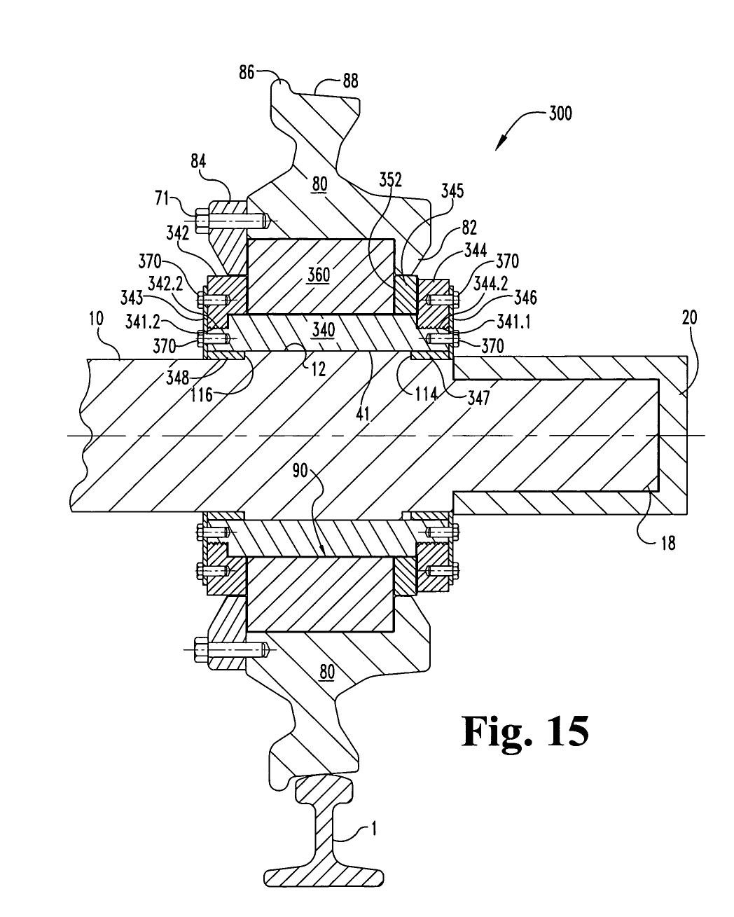

Turning now to FIG. 15, differential wheel mounting 300 is depicted. Differential wheel mounting 300 is similar to several embodiments of differential wheel mountings 100, 200 and 201 described above. Differential wheel mounting 300 can be used with both plain bearing systems as well as rolling bearing systems. In this regard, differential wheel mounting 300 provides an alternate means to secure a bearing member, be it a plain bearing member or a rolling member bearing, on a railroad axle. Similarly, the means for attaching the railroad wheel to the bearing member, as depicted in FIG. 15, is the same as discussed above for differential wheel mounting 100. However, it should be understood that the system for attaching the wheel disclosed in differential wheel mountings 200 and 201, wherein the bearing member is a rolling bearing member, could be used herein as desired.

The new elements in differential wheel mounting 300, as illustrated in FIG. 15, generally includes threaded sleeve 340 having external thread 341.1 and external thread 341.2, threaded shoulder 342 having internal thread 342.2, locking plates 343 and 346, threaded keeper 344 having internal thread 344.2, clamp spacers 347 and 348, bearing member 360 and cap screws 370.

Bearing member 360 may be comprised of one or more rolling bearing components such as tapered roller bearings, tapered thrust roller bearings, needle bearings, ball bearings, roller bearings or any other rolling bearing element known to those skilled in the art. Alternatively, bearing member 360 may be a plain bearing as defined above with regard to bearing 60.

Still referring to FIG. 15, threaded sleeve 340 is adapted to be pressed fit on raised wheel seat 12. In other embodiments threaded sleeve 340 can be pressed fit on raised wheel seat 12 utilizing substantially less force than would be used to press a standard railroad wheel on raised wheel seat 12 in a conventional fashion.

Threaded sleeve 340 includes external threads 341.1 and 341.2 which, as described below, are utilized to attach threaded shoulder and keeper numbers to threaded sleeve 340.

Threaded shoulder 342 is threaded onto threaded sleeve 340 with internal thread 342.2 engaged with external thread 341.2. Threaded shoulder 342 is fixed in place by locking plate 343 which is secured to threaded sleeve 340 and threaded shoulder 342 by a plurality of cap screws 370. Locking plate 342 also secures clamp spacer 348 against inboard step 116.

Threaded keeper 344 is threaded on threaded sleeve 340 with internal threads 344.2 engaging with external threads 341.1. Threaded keeper 344 is secured in position by locking plate 346 which is attached to threaded sleeve 340 and threaded keeper 344 by a plurality of cap screws 370. Locking plate 346 also secures clamp space 347 against outboard step 114.

Threaded sleeve 340 is held in place on axle 10 by a combination of press fit between shoulder 12 and threaded sleeve 340 and/or clamping force exerted by clamp spacers 347 and 348 which are held in place by locking plates 343 and 346.

Keeper spacer 345 is located between bearing member 360 and threaded keeper 344. In one embodiment, keeper spacer 345 is welded to threaded keeper 344. In yet other embodiments, (not illustrated) keeper spacer 345 may be attached to threaded keeper 344 by nut and bolt or by any other means of attachment known to those skilled in the art.

In embodiments where bearing member 360 is a plain bearing type, keeper spacer 345 may include sliding surface 352. Sliding surface 352 has similar function to sliding surface 52 as described above and its inclusion on keeper spacer 345 permits the replacement of keeper spacer 345 as necessitated by wear or damage to sliding surface 352 while retaining and using threaded keeper 344. Use of keeper spacer 345 also permits use of various sized bearings as the size of keeper spacer can be easily adjusted.

The threaded attachment means for threaded keeper 344 and threaded shoulder 342 onto threaded sleeve 340 with differential wheel mounting 300 provides an alternative assembly means that may permit easier maintenance and retro fitting. Furthermore, the use of these threaded components may reduce material usage overall and costs in differential wheel mounting 300 by allowing pre-cast stock to be used which would require minimal machining of the threaded features as opposed to other embodiments that may require custom cast components to avoid wasted material.

Regarding material usage for the components described above for differential mounting 300, in one embodiment utilizing a plain bearing member, threaded sleeve 340, threaded shoulder 342 and keeper spacer 345 are all constructed of a grade of stainless steel adapted for good wear characteristics. Threaded keeper 344 may also be constructed with stainless steel or could alternatively be constructed of lower grade or higher strength material as desired.

Locking plate 343 may be manufactured in at least two separate pieces to permit passage over raised wheel seat 12 during installation. Threaded shoulder 342 may be constructed as one continuous piece or, in alternative embodiments, it is possible to construct threaded shoulder 342 in two or more separate pieces in which case locking plate 343 may be substantially larger to provide reinforcement to union points to form a secure union in the multiple segments of threaded shoulder 342 may be utilized.

Regarding the initial retrofit of a railroad car axle with differential wheel mounting 200, wheel mounting 201 or wheel mounting 202, it is noted that at least one conventional wheel and axle assembly needs to be removed from its interconnection to a railroad car or other similar structure. A conventional railroad wheel is preferably then removed from one end of the standard railroad car axle 110 after removing the adjacent outer axle journal bearing 20 as depicted in FIGS. 11 and 12. However, it is noteworthy that, for some configurations it may be possible to remove the standard railroad wheel over the adjacent outer axle journal bearing. In this case, it may be advantageous to perform the initial retrofit while leaving the outer axle journal bearing 20 in place. In any event, only one of the conventional railroad wheel members needs to be removed and replaced in order to enable and accomplish the benefits and the operation of the preferred embodiments of this disclosure as described herein.

More specifically regarding the initial retrofit situation, after removing the conventional railroad wheel from raised wheel seat 112 as shown in FIGS. 11 and 12, raised wheel seat 112 is carefully inspected to determine its size as well as its fitness to be further utilized. Any required machining to adjust raised wheel seat 112, outboard step 114 or inboard step 116 can then be preformed. Next, the position of the remaining conventional wheel in relation to the outboard step 114 of raised wheel seat 112 is preferably measured to determine how far onto raised wheel seat 112 sleeve 140 should be placed in order to properly position railroad wheel 180 in relation to the conventional railroad wheel remaining to ensure proper engagement with the intended rail gauge. The appropriate sleeve 140 is then selected to insure proper fit as detailed above. Sleeve 140 is then installed onto raised wheel seat 112 using any method known to those skilled in the art, including heavy press fit, light press fit, loose fit, hot shrink fit and warm shrink fit, or sleeve clamps, as described above, until the desired position is reached.

The next step in assembly of the differential wheel mounting is installing rolling member bearing assembly 160, or a portion of rolling member bearing assembly 160, inside wheel 180. This is accomplished by inserting the required components from rolling member bearing assembly 160 into the recess in wheel 180 until shoulder 182 is contacted. Keeper ring 184 is then affixed to wheel 180 such that rolling member bearing assembly 160 is securely held between keeper ring 184 and shoulder 182. Alternatively, rolling member bearing assembly 160 could be press fit into wheel 180. However, it is understood and intended that any means for fastening rolling member bearing assembly 160 to wheel 180 known to those skilled in the art is contemplated by the present disclosure.

The next assembly step is normally installing the assembled wheel 180 and rolling member bearing assembly 160 onto sleeve 140. Rolling member bearing assembly 160, and attached wheel 180, are carefully installed on sleeve 140, by sliding rolling member bearing assembly 160 over sleeve 140 until rolling member bearing assembly 160 substantially contacts shoulder 142. Keeper ring 144 is then installed and affixed to sleeve 140 using cap screws 170. In one embodiment of the present disclosure, keeper ring 144 is segmented (not illustrated) to allow installation of keeper ring 144 over the top of journal 20 where the interior diameter of keeper ring 144 may be too small to permit installation over journal bearing 20. In any event, as previously discussed, it is understood and intended that any means for fastening keeper ring 144 to sleeve 140 known to those skilled in the art is contemplated by the present disclosure.

At this point, wheel 180 is preferably rotatable about axle 110 independently of the rotation of axle 110 by rolling member bearing assembly 160. This provides the standard railroad car axle with one wheel that is capable of independent wheel rotation. This in turn permits the relative rotation or slipping of one of the railroad wheel members on rounding a curve which preferably substantially reduces frictional wear between the running surface 88 of the railroad wheel 80 and a rail.

The afore discussed modifications to a conventional wheel and axle assembly used on railroad cars, including both the differential wheel assemblies with removable plain and rolling bearing members as well as the removable railroad tire wheel describe above, may be readily and efficiently preformed by standard railroad maintenance personnel with typical skills and using common and available equipment. It is envisioned that any of these modifications could take place as a field modification as required due to normal replacement of components, such as after a wheel or journal bearing has been damaged or has reached the end of its useful life. Furthermore, maintenance of this differential wheel mounting may also be readily and efficiently preformed by the same standard railroad maintenance personnel with the same typical skills and common equipment, in particular with respect to the differential wheel assemblies discussed above where a light press fit or a warm shrink fit is used to install sleeve 140 onto wheel seat 112.

While the disclosure has been illustrated and described in detail in the drawings and foregoing description, the same is to be considered as illustrative and not restrictive in character, it being understood that only selected embodiments have been shown and described and that all equivalents, changes, and modifications that come within the spirit of the disclosures as defined herein or by the following claims are desired to be protected. For example, the disclosed keepers, retainers, flanges, shoulders, rings and clamps, whether whole or in part, threaded, drilled, cast, machined or fabricated, along with any other alternative known to those of ordinary skill in the art, are contemplated herein. Similarly, where fastening of elements is required, any fastener known to those of ordinary skill in the art, including, but not limited to bolts, cap screws, rivets and welds, are also contemplated herein.

What is claimed is:

1) A differential wheel mounting for a railroad car having a standard railroad car axle with a raised wheel seat portion and a journal bearing adjacent to at least one end, the differential wheel mounting comprising:
a sleeve mounted to the raised wheel seat portion on the axle, said sleeve having a first shoulder and including a first keeper;
a railroad wheel having a running surface for contacting a rail and a second shoulder and including a second keeper; and
a rolling bearing assembly positioned between said sleeve and said wheel;
wherein said first shoulder and said first keeper laterally confine said rolling bearing assembly with respect to said sleeve and said second shoulder and said second keeper laterally confine said rolling bearing assembly with respect to said wheel;
wherein said rolling bearing assembly sustains radial and thrust loads during normal operation of the railroad car; and
wherein said rolling bearing assembly allows for rotation relative to said railroad wheel and said sleeve.

2) The differential wheel mounting of claim 1, wherein said rolling bearing assembly sustains all loads between said railroad wheel and said sleeve.

3) The differential wheel mounting of claim 1, wherein said rolling bearing assembly can be removed from said sleeve when said first keeper is removed from said sleeve.

4) The differential wheel mounting of claim 3, wherein said rolling bearing assembly and said first keeper can be removed from said sleeve or placed on said sleeve with the journal bearing remaining in place on the end of the axle.

5) The differential wheel mounting of claim 1, wherein said sleeve is press fit on the raised wheel seat portion of the axle.

6) The differential wheel mounting of claim 1, further comprising an interior lip located on the outboard side of said sleeve, wherein said interior lip substantially limits how far inboard said sleeve can be positioned on the axle over the raised wheel seat portion.

7) The differential wheel mounting of claim 1, further comprising a sleeve clamp that is detachably mounted to the circumference of said sleeve on the inboard side of the axle, wherein said sleeve clamp interfaces with the raised wheel seat portion of the axle to substantially constrain movement of said sleeve over the axle in the outboard direction.

8) The differential wheel mounting of claim 1, wherein said rolling bearing assembly is a double row taper bearing.

9) The differential wheel mounting of claim 1, wherein said rolling bearing assembly comprises:
a thrust bearing; and
a roller bearing.

10) The differential wheel mounting of claim 1, wherein said rolling bearing assembly is located closer to the axle than to said running surface.

11) The differential wheel mounting of claim 1, wherein said railroad wheel includes:
a tire portion of said railroad wheel including a third shoulder, said tire portion including said running surface for contacting a rail;
a wheel adaptor including a fourth shoulder, wherein said third shoulder interfaces with said fourth shoulder; and
a mechanical means affixing said tire portion to said wheel adaptor.

12) The differential wheel mounting of claim 11, wherein said mechanical means is a plurality of bolt and nut assemblies that further includes an angled spacer positioned between said nuts and said tire portion.

13) The differential wheel mounting of claim 12, wherein said mechanical means passes through said third shoulder, said fourth shoulder and said angled spacer.

14) The differential wheel mounting of claim 11, wherein said mechanical means is removable and upon removal of said mechanical means, said tire portion is separable from said wheel adaptor.

15) The differential wheel mounting of claim 11, wherein said tire portion is constructed of a first material, said wheel adaptor is constructed of a second material, and said first material is different than said second material.

16) A method for retrofitting a railroad car axle having fixed wheels mounted on wheel seat portions with at least one differential wheel mounting, comprising the steps of:
removing the preexisting wheel from one wheel seat portion on the axle;
providing a selection of different sleeves appropriate to fit different wheel seat portions;
selecting the appropriate sleeve to fit the wheel seat portion on the axle;
securely mounting a sleeve on the wheel seat portion;
detachably mounting a rolling member bearing assembly to a railroad wheel having an outer running surface for contacting a rail; and
detachably mounting the rolling member bearing assembly on the sleeve so that the rolling member bearing assembly is laterally confined on the sleeve to sustain radial and thrust loads experienced during normal operation.

17) The method according to claim 11, further comprising the steps of:
providing different rolling member bearing assembly appropriate to fit the different sleeves; and
selecting the appropriate rolling member bearing assembly for said mounting steps.

18) The method according to claim 12, further comprising the steps of:
providing different keepers appropriate to fit the different sleeves and the different rolling member bearing assembly; and
selecting the appropriate keeper for retaining the rolling member bearing assembly following the mounting steps.

19) A railroad wheel, comprising:
a wheel rim portion constructed of a first material having first material properties;
a wheel hub portion constructed of a second material having second material properties;
wherein said first material properties are different than said second material properties;
wherein said wheel rim portion is removably affixed to said wheel hub portion.

20) The railroad wheel of claim 19, wherein said first material is different than said second material.
